(19) United States
(12) Patent Application Publication
(10) Pub. No.: US 2007/0031119 A1
(43) Pub. Date: Feb. 8, 2007

(54) Playback apparatus

(75) Inventor: Akihiro Iwanaga, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/497,328

(22) Filed: Aug. 2, 2006

(30) Foreign Application Priority Data
Aug. 2, 2005 (JP) 2005-224370

(51) Int. Cl. H04N 7/00

(52) U.S. Cl. 386/95

(57) ABSTRACT

A playback apparatus includes a scene change position detecting unit that detects a scene change position closest in a playback direction to a playback position at the time that a scene skip request was input during playback of a program recorded on a recording medium, and a scene skipping unit that skips the playback position to the scene change position detected by the scene change position detecting unit. The scene change position detecting unit detects the scene change position based on the change in bit rate of video in the recorded data.

### CROSS REFERENCE

This Nonprovisional application claims priority under 35 U.S.C. § 119(a) on Patent Application No. 2005-224370 filed in Japan on Aug. 2, 2005, the entire contents of which are hereby incorporated by reference.

### BACKGROUND OF THE INVENTION

The present invention relates to a playback apparatus that reads recorded data of a program recorded on a recording medium such as a DVD or a hard disk, and plays the program based on the recorded data.

### SUMMARY OF THE INVENTION

Conventionally, playback apparatuses that play programs recorded on recording media such as DVD and HD (hard disk) have become commercially viable and are in widespread use. This type of playback apparatus includes those having a CM skip function for playing programs recorded on recording media while skipping commercial messages (hereinafter, “CMs”) inserted in the programs, as proposed by JP H9-307841A. When an input operation related to CM skipping is performed by the user during playback of a program recorded on a recording medium, this CM skip function switches playback of the program from normal playback to fast forward playback, and then stops fast-forward playback and resumes normal playback at the point at which there is a switch from CM to main program. Consequently, the user is able to skip (play in fast forward) CMs inserted in the main program by performing an input operation related to CM skipping when the playback position of a program recorded on a recording medium reaches a CM portion.

JP H9-307841A proposes a CM skip function directed towards television broadcasts in the United States and Europe. With television broadcasts in the United States and Europe, a number of black frames (a so-called “black screen”) are inserted between individual CMs and between CMs and the main program. The number of black frames inserted where there is a switch from CM to main program is greater than the number of black frames inserted between individual CMs. With JP H9-307841A, normal playback is switched to fast forward playback when an input operation related to CM skipping is performed, and black frames inserted where there is a switch from CM to main program are detected. Detecting black frames inserted where there is a switch from CM to main program involves firstly detecting black frames and then judging whether the number of inserted black frames is greater than a prescribed number of black frames (the number of black frames inserted between individual CMs). Here, if it is judged to be greater, the detected black frames are detected as black frames inserted where there is a switch from CM to main program. On the other hand, if judged to be less than or equal to the prescribed number of black frames, the detected black frames are judged to be black frames inserted between individual CMs, and the processing to detect black frames is repeated in the playback direction. Fast forward playback is then stopped at the position at which black frames inserted where there is a switch from CM to main program are detected, and normal playback is resumed.

A playback apparatus having a mark setting function that enables playback to be started from a marked position by setting a desired playback position as the marked position has heretofore been proposed by JP 2004-356793A. With JP 2004-356793A, when an input related to setting amarked position is performed during fast forward playback, the closest scene change position on the rewind side to the playback position at the time of the input is detected, and the detected scene change position is set as the marked position. JP 2004-356793A also utilizes the fact that the bit rate of video differs between scenes, with the place where the change in video bit rate is greater than a predetermined value being detected as the scene change position.

However, with the foregoing CM skip function, skipping the playback position to the start of the next scene (so-called “scene skipping”) was not possible. With a conventional playback apparatus, for example, the user had to perform an input operation related to fast forward playback when he or she wanted to skip a dialogue scene currently being played and watch an action scene that follows the dialogue scene, and then perform an input operation to stop the fast forward playback and resume normal playback at the start of the action scene. Performing the input operation to stop fast forward playback and resume normal playback exactly at the start of the next scene is not easy, possibly resulting in normal playback being resumed just before or just after the start of the desired scene.

In the case of a playback apparatus having the mark setting function described in JP 2004-356793A, scene skipping can be performed in relation to programs recorded on recording media by setting the start position of each scene as a marked position. However, the user must perform the setting operation to set the start position of each scene as a marked position beforehand. Moreover, the operation to set the start position of each scene as a marked position is troublesome for the user.

As such, the usability of conventional playback apparatuses has not been sufficiently improved in relation to scene skipping.

An object of the present invention is to provide a playback apparatus in which the usability of scene skipping to skip a scene currently being played and playback from the start of the next scene is improved.

### SUMMARY OF THE INVENTION

A playback apparatus according to the present invention includes a scene change position detecting unit that detects a scene change position closest in a playback direction to a playback position at the time that a scene skip request is input during playback of a program recorded on a recording medium, and a scene skipping unit that skips the playback position to the scene change position detected by the scene change position detecting unit. The scene change position detecting unit detects the scene change position based on a change in bit rate of video in the recorded data.

Even in the same program, the video bit rate changes depending on whether the scene is a dialogue scene, action scene, or the like. Consequently, the user is able to skip the scene currently being played and watch from the start of the next scene simply by performing an input operation related to inputting a scene skip request, without setting the start of each scene of the program as amarked position. Thus, the usability of scene skipping to skip a scene currently being played and playback from the start of the next scene can be sufficiently improved.

### BRIEF DESCRIPTION OF THE DRAWINGS

FIG. 1 is a block diagram showing the configuration of a main part of a playback apparatus according to an embodiment of the present invention.

FIGS. 2A and 2B show recorded data of a program recorded on DVD.

FIG. 3 is a flowchart showing playback processing in a playback apparatus according to an embodiment of the present invention.

FIG. 4 is a flowchart showing scene skip processing in a playback apparatus according to an embodiment of the present invention.

FIG. 5 is a flowchart showing scene repeat processing in a playback apparatus according to an embodiment the present invention.

### DETAILED DESCRIPTION OF THE INVENTION

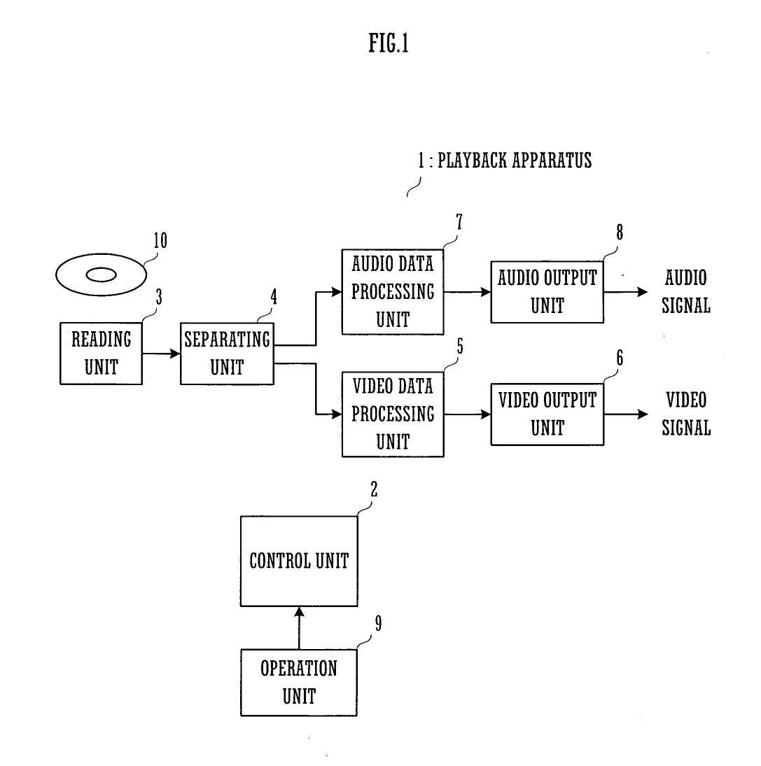

FIG. 1 is a block diagram showing the configuration of a main part of a playback apparatus according to an embodiment of the present invention. A playback apparatus 1 of the present embodiment plays a program recorded on a DVD 10. The playback apparatus 1 includes a control unit 2 that controls the operation of the playback apparatus, a reading unit 3 that reads recorded data of the program recorded on the DVD 10 loaded, and a separating unit 4 that separates the recorded data read by the reading unit 3 into video data and audio data. The playback apparatus 1 also includes a video data processing unit 5 that processes the video data separated by the separating unit 4, a video output unit 6 that outputs a video signal which is based on the video data processed by the video data processing unit 5, an audio data processing unit 7 that processes the audio data separated by the separating unit 4, and an audio output unit 8 that outputs an audio signal which is based on the audio data processed by the audio data processing unit 7. The playback apparatus 1 further includes an operation unit 9 that receives inputs.

The control unit 2 instructs the various units of the playback apparatus 1 to operate. The reading unit 3 has a publicly known pickup head for reading recorded data of the program recorded on the DVD 10. The program on the DVD 10 is recorded using a system stream encoded with MPEG 2 or the like. The reading unit 3 also has a servo control unit that performs a focus control for focusing a laser beam irradiated onto the DVD 10 from the pickup head on the recording surface of the DVD 10, and a tracking control for controlling the irradiation position of the laser beam to be at the center of the tracks on the DVD 10. Description of the focus control and the tracking control of the servo control unit is omitted here.

The reading unit 3 inputs the recorded data read from the DVD 10 to the separating unit 4. This recorded data is a system stream in which the video and audio data of the program has been packetized into prescribed units and multiplexed. The separating unit 4 processes the system stream input from the reading unit 3, separating the system stream into video data and audio data. The separating unit 4 inputs the video data separated from the system stream to the video data processing unit 5, and inputs the audio data to the audio data processing unit 7. The video data processing unit 5 decodes the video data input from the separating unit 4. The video data processing unit 5 also has a function for detecting the bit rate of the video data. The bit rate of the video data may be obtained from the data volume of video data per time unit (1 second) of playback video, for example, or from the playback time and data volume of one GOP (Group Of Pictures). The video data processing unit 5 inputs the decoded video data to the video output unit 6, and notifies the detected bit rate of the video data to the control unit 2.

The audio data processing unit 7 decodes the audio data input from the separating unit 4. The audio data processing unit 7 inputs the decoded audio data to the audio output unit 8. The video output unit 6 outputs a video signal that is based on the video data decoded by the video data processing unit 5. A display apparatus (not shown) such as a television receiver is connected to the video output unit 6. The display apparatus displays video according to the video signal input from the video output unit 6. The audio output unit 8 outputs an audio signal that is based on the audio data decoded by the audio data processing unit 7. A speaker (not shown) is connected to the audio output unit 8. The speaker outputs audio according to the audio signal input from the audio output unit 8. The operation unit 9 is provided with operation keys for performing input operations on the playback apparatus 1, and a remote control receiving unit for receiving control signals transmitted to the playback apparatus 1 from a remote control apparatus not shown in the drawings. The user performs input operations on the playback apparatus 1 by operating the operation keys provided on the operation unit 9, or by operating the operation keys of the remote control apparatus not shown in the drawings.

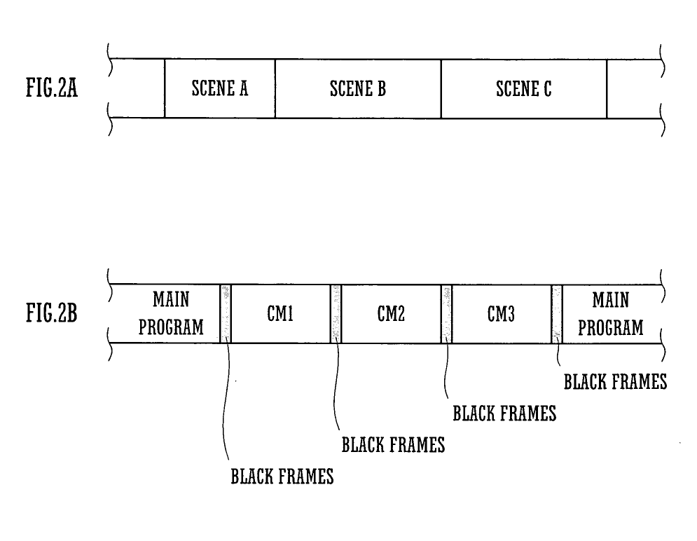

The video bit rate of the program recorded on the DVD 10 differs depending on whether the scene is a dialogue scene, action scene, or the like. For example, in a program in which three scenes A, B and C are consecutive in the stated order, as shown in FIG. 2A, the video of scene A is recorded on the DVD 10 at a bit rate of a bit/s, the video of scene B is recorded at a bit rate of b bit/s, and the video of scene C is recorded at a bit rate of cbit/s. The difference in video bit rate between scenes is at least several kbit/s, being 5 kbit/s, for example. Black frames may be inserted between individual scenes. With television broadcasts in the United States and Europe, a number of black frames are inserted between individual CMs as well as between CMs and the main program, as shown in FIG. 2B. FIG. 2B shows an example in which three CMs (CM1, CM2, CM3) are inserted in the main program. Needless to say, these black frame and CMs are also recorded to the DVD 10 when a program with black frames inserted between individual CMs and between CMs and the main program is recorded.

The playback apparatus 1 of the present embodiment further has a scene skip function for skipping the playback position to the start of the next scene after the scene being played at that time, and a scene repeat function for skipping to the start of the scene being played at that time, when playing of a program recorded on the DVD 10. When a scene skip request is input during playback of scene A shown in FIG. 2A, for example, the scene skip function skips the playback position to the start of scene B. Again, when a scene skip request is input during playback of CM1 shown in FIG. 2B or during playback of the main program immediately preceding CM1, the scene skip function skips the playback position to the start of the main program after CM3, thus making it possible to skip CMs inserted in the main program, similarly to a conventional CM skip function. When a scene repeat request is input during playback of scene A shown in FIG. 2A, for example, the scene repeat function skips the playback position to the start of scene A. Again, when a scene repeat request is input during playback of CM1 shown in FIG. 2B, the scene repeat function skips the playback position to the start of CM1.

The operation unit 9 and the remote control apparatus, which is not shown in the drawings, are provided with a scene skip key that is operated when inputting a scene skip request, and a scene repeat key that is operated when inputting a scene repeat request. By using the scene skip function, the user is able to skip a scene currently being played and watch the next scene, or skip CMs. By using the scene repeat function, the user is able to watch a scene or CM currently being played from the beginning again.

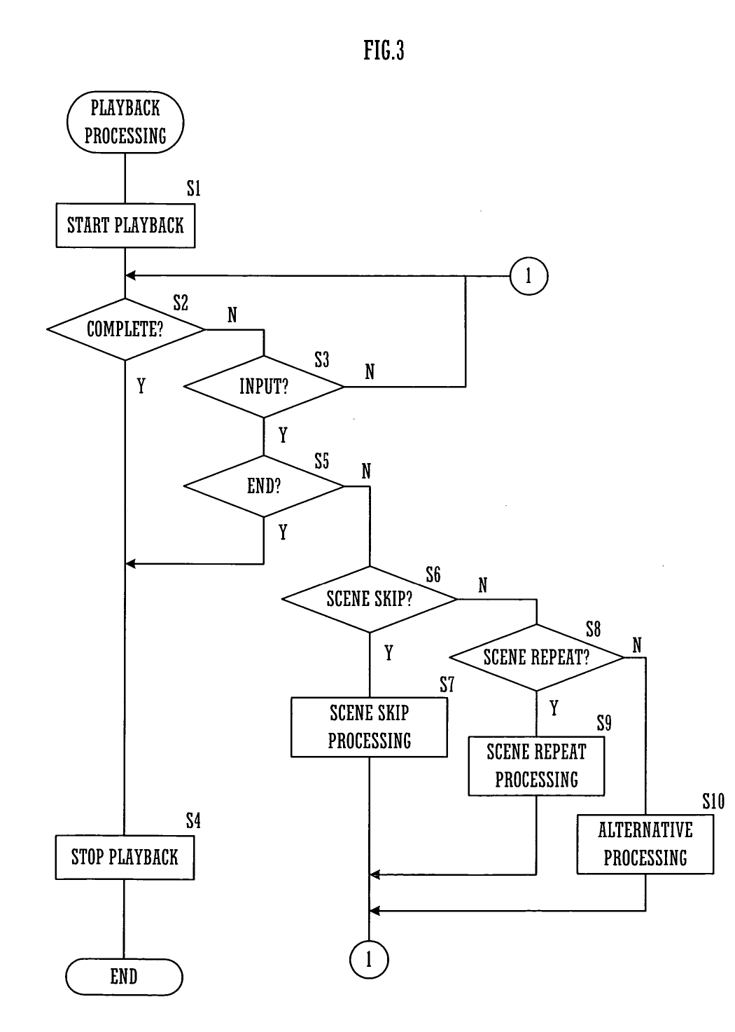

The operation of the playback apparatus 1 of the present embodiment is described below. When an input operation to start playback is performed, the playback apparatus 1 of the present embodiment starts playback processing to play a program recorded on the DVD 10 loaded. FIG. 3 is a flowchart showing playback processing in the playback apparatus 1 of the present embodiment. The playback apparatus 1 starts playing a program (recorded on the DVD 10) specified for playback (S1). At S1, the reading unit 3 starts reading the recorded data of the specified program from the DVD 10. The separating unit 4 starts processing to separate the recorded data of the program read from the DVD 10 by the reading unit 3 into video data and audio data. The separating unit 4 inputs the separated video data to the video data processing unit 5, and inputs the separated audio data to the audio data processing unit 7. The video data input to the video data processing unit 5 and the audio data input to the audio data processing unit 7 is encoded data. The video data processing unit 5 decodes the video data input from the separating unit 4, and inputs the decoded video data to the video output unit 6. The video data processing unit 5 also starts processing to detect the bit rate of the decoded video data, and notify the detected bit rate to the control unit 2. The audio data processing unit 7 decodes the audio data input from the separating unit 4, and inputs the decoded audio data to the audio output unit 8. The video output unit 6 outputs a video signal that is based on the video data decoded by the video data processing unit 5. The audio output unit 8 outputs an audio signal that is based on the audio data decoded by the audio data processing unit 7. The video output unit 6 and the audio output unit 8 output the video signal and the audio signal in sync. Thus, video of the program read from the DVD 10 by the reading unit 3 is displayed by the display apparatus connected to the video output unit 6, and audio of the program is output from the speaker connected to the audio output unit 8.

The playback apparatus 1, having started to play the program at S1, waits until program playback is complete (S2), or waits for an input (S3). At S2, the playback apparatus 1 judges that program playback is complete when the program with respect to which playback was started has been played to the end. The playback apparatus 1, having judged at S2 that program playback is complete, stops playback of the program started at S1 (S4), and ends the processing. On the other hand, the playback apparatus 1, having judged at S3 that an input, stops playback of the program at S4 if the input is to end playback (S5), and ends the processing.

The playback apparatus 1, having judged that the input to a scene skip request, performs scene skip processing (S6, S7), which is described hereinafter, and returns to S2. The playback apparatus 1, having judged that the input to a scene repeat request, performs scene repeat processing (S8, S9) which is described hereinafter, and returns to S2. Further, the playback apparatus 1, having judged that the input to the playback apparatus is an input other than the above, executes processing according to the input (the alternative processing), which may be processing to pause playback, for example (S10), and returns to S2. A scene skip request can be input by operating the scene skip key of either the operation unit 9 or the remote control apparatus. A scene repeat request can be input by operating the scene repeat key of either the operation unit 9 or the remote control apparatus.

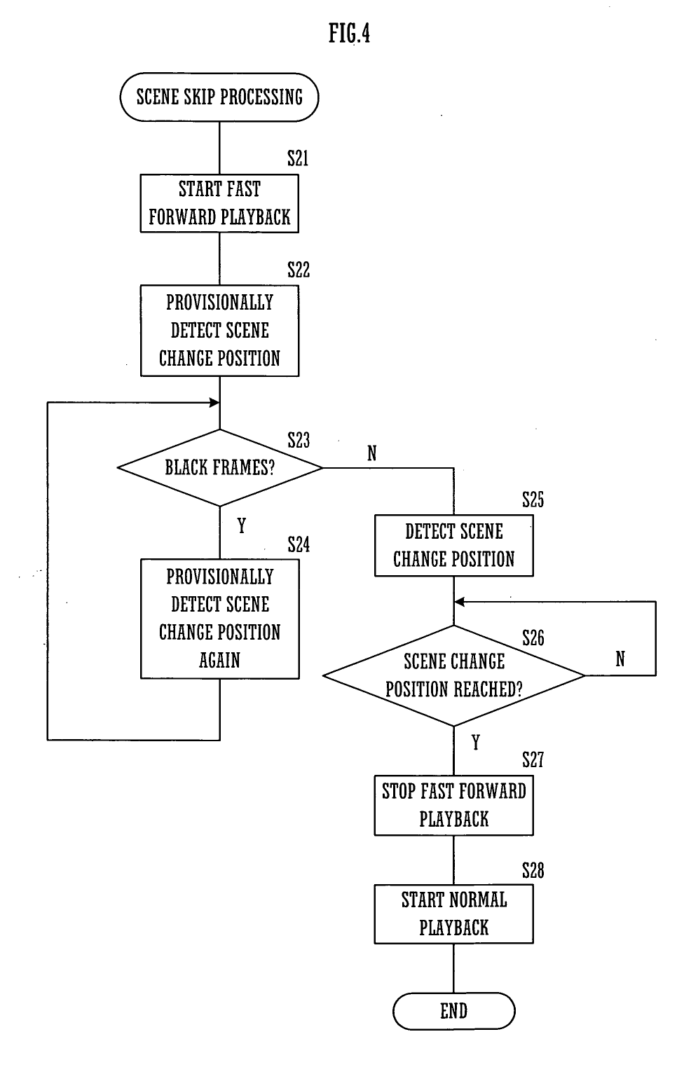

The scene skip processing related to S7 is described next. When the user wants to skip a scene being played at that time and watch the next scene, or when the user want to skip a CM being played at that time and watch the main program, he or she operates the scene skip key of the operation unit 9 or the remote control apparatus to execute scene skip processing. FIG. 4 is a flowchart showing scene skip processing in the playback apparatus 1 of the present embodiment. The playback apparatus 1 starts fast forward playback from the playback position at that time; that is, the playback position at the time that the scene skip request is input (S21). With this fast forward playback, output of the audio signal from the audio output unit 8 is stopped. Video for the period during which fast forward playback is performed is displayed on the display apparatus by decimating the video frames and outputting the decimated video from the video output unit 6.

The playback apparatus 1 provisionally detects, as the scene change position, a position at which the video bit rate in the playback direction changes by more than a predetermined value from the playback position of the DVD 10 at the time that the input related to scene skipping was performed (S22). At S22, a position at which the absolute value of the difference in video bit rate exceeds a predetermined value of 5 kbit/s, for example, is provisionally detected as the scene change position. The video bit rate may be obtained from the data volume of video per unit of playback time (e.g., 1 second), or from the data volume and playback time of video per GOP (Group Of Pictures). Detection of the video bit rate is performed in the video data processing unit 5 as noted above. The control unit 2 provisionally detects the scene change position based on the bit rate notified by the video data processing unit 5. When provisionally detecting the scene change position, the control unit 2 may provisionally detect, as the scene change position, a position at which the absolute value of the difference from the video bit rate at the playback position of the DVD 10 at the time that the input related to scene skipping was performed exceeds a predetermined value of 5 kbit/s, for example, or a position at which the absolute value of the difference between two temporally consecutive areas (whose video bit rate has been obtained) exceeds a predetermined value of 5 kbit/s, for example.

The playback apparatus 1, having provisionally detected the scene change position at S22, judges whether black frames exist within a prescribed time period in the playback direction from the provisionally detected scene change position (S23). This prescribed time period is set to be slightly longer than the duration of an average CM. Specifically, the prescribed time period is set to 20-30 seconds, given an average CM duration of 15 seconds. With television broadcasts in the United States and Europe, a number of black frames are inserted between individual CMs inserted in the main program as well as between CMs and the main program, as noted above. When the program currently being played has black frames inserted between individual CMs and between CMs and the main program, the scene change position provisionally detected at S22 may be a black frame or the start of a CM, depending on the playback position at the time that the scene skip request is input. Of course, the provisionally detected scene change position may also be the start of a scene in the main program. Normally, a single scene in the main program is several minutes to ten-several minutes in length. At S23, the playback apparatus 1 judges whether the provisionally detected scene change position is a black frame or the start of a CM, or whether it is the start of a scene in the main program.

Having judged at S23 that black frames exist within the prescribed time period, that is, having judged that the provisionally detected scene change position is a black frame or the start of a CM, the playback apparatus 1 provisionally detects the video immediately after the black frame as the scene change position (S24), and returns to S23. The playback apparatus 1 repeats the processing of S23 and S24 until it is judged that black frames do not exist within the prescribed time period; that is, until the start of a scene is detected as the scene change position. The playback apparatus 1, having judged at S23 that black frames do not exist within the prescribed time period from the provisionally detected scene change position, detects this scene change position as the scene start position of the main program closest in the playback direction to the playback position at the time that the skip scene request was input (S25).

When the playback position from which fast forward playback was started at S21 reaches the start of the scene detected at S25 (S26), the playback apparatus 1 stops the fast forward playback (S27). The playback apparatus 1 then starts normal playback (S28), and ends the processing. The playback apparatus 1, having ended the scene skip processing, returns to S2 described above.

In this way, the playback apparatus 1 of the present embodiment is able to perform scene skipping to skip a scene currently being played and playback from the start of the next scene for viewing, with a simple operation involving the operation of a scene skip key. Consequently, usability related to scene skipping can be sufficiently improved. Even when the user wants to skip CMs inserted in the main program, the playback apparatus 1 of the present embodiment is able to skip CMs with operation of the scene skip key. Consequently, the user does not need to change the input operation on the playback apparatus 1 depending on whether he or she wants to skip a scene or a CM currently being playback. Operational errors by the user are thus suppressed, enabling usability to be further improved.

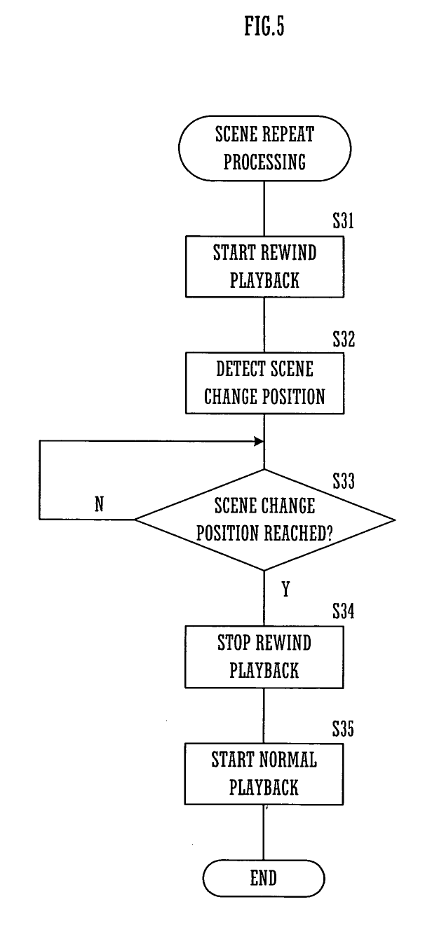

The scene repeat processing related to. S9 is described next. FIG. 5 is a flowchart showing this scene repeat processing. When the user wants to watch a scene or CM that is being played at that time again from the start, he or she operates the scene repeat key of either the operation unit 9 or the remote control apparatus to execute this scene repeat processing. The playback apparatus 1 starts rewind playback from the playback position at that time; that is, the playback position at the time that the scene repeat request is input (S31). With this rewind playback, output of the audio signal from the audio output unit 8 is stopped. Also, video for the period during which rewind playback is performed is displayed on the display apparatus by decimating the video frames and outputting the decimated video from the video output unit 6.

The playback apparatus 1 detects, as the scene change position, a position at which the bit rate of video in the rewind direction changes more than a predetermined value from the playback position of the DVD 10 at the time that the input related to scene repetition was performed (S32). At S32, a position at which the absolute value of the difference in video bit rate exceeds a predetermined value of 5 kbit/s, for example, is detected as the scene change position, similarly to S22 in the foregoing scene skip processing. Detection of the video bit rate is performed in the video data processing unit 5 as noted above. The control unit 2 detects the scene change position based on the bit rate notified by the video data processing unit 5. With this scene repeat processing as well, the control unit 2 may detect, as the scene change position, a position at which the absolute value of the difference from the video bit rate at the playback position of the DVD 10 at the time that the input related to scene repetition was performed exceeds a predetermined value of 5 kbit/s, for example, or a position at which the absolute value of the difference between two temporally consecutive areas (whose video bit rate has been obtained) exceeds a predetermined value of 5 kbit/s, for example.

Depending on the playback position at the time that the scene repeat request is input, the scene change position detected at S32 may be the start of a scene being played at that time, or it may be the start of a CM being played at that time. When the playback position from which rewind playback was started at S31 reaches the start of the scene detected at S32 (S33), the playback apparatus 1 stops the rewind playback (S34). The playback apparatus 1 then starts normal playback (S35), and ends the processing. The playback apparatus 1, having ended the scene repeat processing, returns to S2 described above.

Consequently, when the user wants to watch a scene currently being played again from the beginning, or if the user is interested in a CM currently being played and wants to watch it again, he or she is able to watch the scene or CM again from the beginning simply by operating the scene repeat key of either the operation unit 9 or the remote control apparatus. In this way, the playback apparatus 1 of the present embodiment enables a scene or CM currently being played to be watched again from beginning by a simple operation involving the operation of a scene repeat key. Usability related to scene repetition is thus also improved.

Note that although the present invention is described in the foregoing embodiment using the example of a playback apparatus 1 that plays a program recorded on the DVD 10, the present invention can be applied in relation to a playback apparatus 1 that plays a program recorded on a recording medium other than DVD, such as a hard disk or the like. In addition, the present invention can also be applied in a record/playback apparatus that has a recording function for recording televised programs.

Finally, the description of the foregoing embodiment is in all respects illustrative and not limiting. The scope of the invention is indicated by the scope of the claims rather than by the foregoing embodiment. Further, all changes that come within the meaning and range of equivalency of the claims are intended to be embraced in the scope of the present invention.

What is claimed is:

1. A playback apparatus comprising:
a reading unit that reads recorded data of a program recorded on a recording medium;
a playback unit that outputs a playback signal which is based on the recorded data read by the reading unit;
a scene change position detecting unit that detects a scene change position closest in a playback direction to a playback position at a time when a scene skip request is input during playback of the program by the playback unit; and
a scene skipping unit that skips the playback position in the playback unit to the scene change position detected by the scene change position detecting unit, wherein
the scene change position detecting unit detects the scene change position based on a change in bit rate of video in the recorded data.

2. The playback apparatus according to claim 1, wherein the scene change position detecting unit provisionally detects the scene change position based on the change in bit rate of video in the recorded data, and detects the provisionally detected scene change position as the closest scene change position in the playback direction if black frame video does not exist within a prescribed time period in the playback direction from the provisionally detected scene change position, and
if black frame video does exist within the prescribed time period in the playback direction from the provisionally detected scene change position, the scene change position detecting unit repeats processing to provisionally detect video following the black frame video as a scene change position until a scene change position is provisionally detected that does not have black frame video existing within the prescribed time period in the playback direction therefrom, and detects the provisionally detected scene change position that does not have black frame video existing within the prescribed time period in the playback direction therefrom as the closest scene change position in the playback direction.

3. The playback apparatus according to claim 1, wherein the scene skipping unit starts fast forward playback by the playback unit when the scene skip request is input, and stops fast forward playback by the playback unit and resumes normal playback when the playback position reaches the scene change position detected by the scene change position detecting unit.
